(19) United States
(12) Patent Application Publication
(10) Pub. No.: US 2015/0295863 A1
(43) Pub. Date: Oct. 15, 2015

(54) METHOD AND SYSTEM FOR PROCESSING INCOMING MESSAGES

(71) Applicant: Tencent Technology (Shenzhen) Company Limited, Shenzhen (CN)

(72) Inventors: Liwei YE, Shenzhen (CN); Wei Yi, Shenzhen (CN); Jing He, Shenzhen (CN); Bin Li, Shenzhen (CN)

(21) Appl. No.: 14/747,999

(22) Filed: Jun. 23, 2015

Related U.S. Application Data
(63) Continuation of application No. PCT/CN2013/084993, filed on Oct. 10, 2013.

(30) Foreign Application Priority Data
Dec. 24, 2012 (CN) 201210566951.6

(51) Int. Cl. H04L 12/58; G06F 3/0484; G06F 17/30; G06F 3/0482

(52) U.S. Cl. CPC H04L 51/046; G06F 3/0482; G06F 3/04847; G06F 3/04842; G06F 17/30424

(57) ABSTRACT

A message processing method and a computing device running on an IOS platform are provided. The method includes: capturing a new message notification thrown by an underlying communication module of an IOS system, the new message notification including a message identifier (ID); querying a message database by using the message ID, to acquire associated information of a message corresponding to the message ID, the associated information including one or more of message content, a message type, and information about a message sender; and displaying the found associated information in a pop-up window.

### RELATED APPLICATIONS

This application is a continuation application of PCT Patent Application No. PCT/CN2013/084993, entitled “iOS Platform-based Message Processing Method and System” filed on Oct. 10, 2013, which claims priority to Chinese Patent Application No. 201210566951.6, filed with the State Intellectual Property Office of the People's Republic of China on Dec. 24, 2012, and entitled “iOS Platform-based Message Processing Method and System”, both of which are incorporated herein by reference in their entirety.

### FIELD OF THE TECHNOLOGY

The present disclosure relates to message processing technologies based on an IOS platform, and in particular, to a message processing method based on an IOS platform and a message processing system based on an IOS platform.

### BACKGROUND OF THE DISCLOSURE

With features such as simple design and being easy to operate, an IOS (a handheld device operating system developed by Apple Inc.) platform is accepted by more and more users, and is used on an increasingly large number of devices on the market. However, the IOS platform is originally designed to cater for user experience in entertainment mainly, and only supports some simple operations among common message processing operations.

A current message function provided by the IOS platform can receive three types of messages, namely, short messaging service message, multimedia message, and iMessage (which is an instant messaging service provided by Apple Inc.); after receiving a message, an IOS system informs a user of the new message by means of a notification, and displays, on a system message icon, a number that represents the quantity of unread messages at present. The user may choose a form for new message notification, such as a prompt in a form of a pop-up dialog box, or a form of a banner, to inform the user of the new message. The user may tap a button on the dialog box or the banner to enter a message program of the IOS system, and switch to and invoke the message program of the system to display details of the message. In this message processing manner, none of processing operations on the message, including viewing the message, marking the message as read, deleting the message, replying to the message and the like, can be directly performed in a currently used application; a user needs to switch the currently used application to the background, then switch to a system message processing program, and complete a corresponding operation in the system message program. Using a game as an example, a user needs to manually set the game to a pause state, and then switch to a system message processing program. After the operation is completed, the previously used program cannot be restored automatically, but needs to be started again manually, which causes low message processing efficiency.

### SUMMARY

To solve the foregoing problems in the existing technology, the present disclosure is directed to a message processing method based on an IOS platform and a message processing system based on an IOS platform, which can implement quick message processing on the IOS platform without the necessity of switching an application.

To achieve the foregoing objective, the present disclosure uses the following technical solutions:

A message processing method based on an IOS platform is at a computing device running on the IOS platform, the computing device having one or more processors and memory for storing a plurality of program modules to be executed by the one or more processors, the method including:

capturing a new message notification thrown by an underlying communication module of an IOS system, the new message notification including a message identifier (ID);

querying a message database by using the message ID, to acquire associated information of a message corresponding to the message ID, the associated information including one or more of message content, a message type, and information about a message sender; and

displaying the found associated information in a pop-up window.

A computing device running on an IOS platform includes one or more processors, memory, and a plurality of program modules stored in the memory and to be executed by the one or more processors, the plurality of program modules further including:

a capture module, configured to capture a new message notification thrown by an underlying communication module of an IOS system, the new message notification including a message identifier (ID);

an information query module, configured to query a message database by using the message ID, to acquire associated information of a message corresponding to the message ID, the associated information including one or more of message content, a message type, and information about a message sender; and

a pop-up window display module, configured to display the associated information in a pop-up window.

A non-transitory computer readable medium storing a plurality of program modules in conjunction with a computing device running on an IOS platform and having one or more processors, wherein the plurality of program modules, when executed by the one or more processors, cause the computing device to perform the following operations:

capturing a new message notification thrown by an underlying communication module of an IOS system, the new message notification including a message identifier (ID);

querying a message database by using the message ID, to acquire associated information of a message corresponding to the message ID, the associated information including one or more of message content, a message type, and information about a message sender; and

displaying the found associated information in a pop-up window.

According to the solutions of the present disclosure, a notification that is about a new message and is thrown by an underlying communication module of an IOS system is captured; the new message notification includes a unique ID that is in a message database and corresponding to the message, and therefore, the message database may be queried according to the message ID, to acquire all associated information of the message corresponding to the message ID, and after the associated information is acquired, the found associated information is displayed in a pop-up window. In this message processing manner, it is unnecessary to switch to a system message processing program, and a received new message can be displayed in a pop-up window without switching a currently used application; moreover, a related processing operation can be performed on the message when the message is displayed in the form of the pop-up window, thereby implementing quick message processing without switching the application.

### BRIEF DESCRIPTION OF THE DRAWINGS

FIG. 1 is a schematic flowchart of an embodiment of a message processing method based on an IOS platform according to the present disclosure;

FIG. 2 is a schematic diagram of a specific example of message display in a pop-up window;

FIG. 3 is a schematic diagram of a specific example of message reply in a pop-up window; and

FIG. 4 is a schematic structural diagram of an embodiment of a message processing system based on an IOS platform according to the present disclosure.

### DESCRIPTION OF EMBODIMENTS

The following describes solutions of the present disclosure in detail with reference to preferred embodiments. In the following description, an embodiment of a message processing method based on an IOS platform of the present disclosure is first described, and an embodiment of a message processing system based on an IOS platform of the present disclosure is then described.

FIG. 1 is a schematic flowchart of an embodiment of a message processing method based on an IOS platform according to the present disclosure. As shown in FIG. 1, the message processing method based on an IOS platform according to the this embodiment may include the following steps:

Step S101: Capture a new message notification thrown by an underlying communication module of an IOS system, where the new message notification includes a message identifier (ID).

Step S102: Query a message database by using the message ID, to acquire associated information of a message corresponding to the message ID, where the associated information may include, for example, message content, a message type, and information about a message sender. The information about the message sender may be any one or any combination of a name of the message sender, a number of the message sender, an image of the message sender, an address of the message sender, and other information related to the message sender.

Step S103: Display the found associated information in a pop-up window.

According to the method of this embodiment, a notification that is about a new message and is thrown by an underlying communication module of an IOS system is captured; the new message notification includes a unique ID that is in a message database and corresponding to the message, and therefore, the message database may be queried according to the message ID, to acquire all associated information of the message corresponding to the message ID, and after the associated information is acquired, the found associated information is displayed in a pop-up window. In this message processing manner, it is unnecessary to switch to a system message processing program, and a received new message can be displayed in a pop-up window without switching a currently used application; moreover, a related processing operation can be performed on the message when the message is displayed in the form of the pop-up window, thereby implementing quick message processing without switching the application.

The message ID is a unique ID that is in the message database and corresponding to the message. Content of the message and other related information, such as a message type (for example whether the message is a short messaging service message or an iMessage, and whether the message is a text or an image) and information about a message sender (such as a name, an image, and a telephone number) can be found in the message database according to the message ID.

In a current message processing manner of an IOS system, after receiving a new message, an underlying communication module of the IOS system throws a new message notification to a system message program in a form of a prompt; and after receiving the prompt, the system message program informs a user of the new message according to a message prompt manner selected by the user, and displays, on a system message icon, the quantity of unread messages. In the solution of the present disclosure, the new message notification thrown to the system message program by the underlying communication module of the IOS system is captured, so as to process the newly received message without starting a processing mechanism of the system message program.

When the pop-up window is displayed, the currently used application may pause, so as to ensure continuity of the currently used program and facilitate processing on the message displayed in the pop-up window. For example, when a game program is executed currently, the game may be set to a pause state, so as to ensure that a procedure of the game is not affected when pop-up window is displayed, and ensure continuity of the game after processing on message content displayed in the pop-up window is completed. If the system is currently in a lock state, the lock state is released temporarily, so that a related processing operation can be performed on the pop-up window; and after message processing is completed, the lock state is automatically restored without the necessity of locking the screen manually. Therefore, it can be known that the pop-up window is displayed on a lock screen, a desktop or an application interface when displaying the found associated information in the pop-up window.

Besides, when displaying the found associated information in the pop-up window, a preset message alert tone may further be played, or a device running the IOS system may be made to vibrate, so as to inform the user of the new message.

When the foregoing message content is displayed in the pop-up window, related optimizing processing may further be performed. When there is excessive message content, the user can view the complete message by sliding the message content up and down, that is, the message content is displayed in a slide manner when a vertical slide instruction is received. On the other hand, multiple messages may be received at the same time, and to make it convenient for the user to view each message, a horizontal slide manner may be employed, so that the user can view each message, that is, the pop-up display window switches to display another message when a horizontal slide instruction is received.

As described above, after the associated information of the message corresponding to the message ID is found in the message database, the acquired associated information needs to be displayed in the pop-up window. In this embodiment, the information displayed in the pop-up window may include, for example, message content, information about a message sender and a message processing control. Besides, the associated information found in the message database may further include a message type, where the message type represents, for example, whether the newly received message is a short messaging service message, a multimedia message or an iMessage; moreover, the message type may also represent, for example, whether the message is a text or an image; and a pop-up window display manner may further be determined according to the message type when the message content is displayed in the pop-up window.

The message processing control herein includes, for example, any one or any combination of a message reply control, a control for marking a message as read, and a message deletion control. The message processing control provided in the pop-up window is used to facilitate interaction between the user and these message processing controls, thereby implementing message processing. During specific implementation, the message processing control may be presented in the form of a button, a text box, a dialog box, or the like. According to an actual need, other types of message processing controls may further be included; and in the embodiment of the present disclosure, the message reply control, the control for marking a message as read, and the message deletion control are used as examples for description.

By using the message reply control as an example, the control is provided so that the user can directly reply to the message in the pop-up window. The message content is displayed in the pop-up window; the user views the message content, and taps the message reply control in the pop-up window after determining to reply to the message; the pop-up window receives a reply instruction by using the message reply control, a text input box is opened in the pop-up window according to the received reply instruction, and a message sending control is provided; the user inputs, in the text input box, a reply message that needs to be sent to the other party, and then taps the message sending control; the pop-up window receives a message sending instruction by using the message sending control, and sends out the message received in the text input box by using the underlying communication module of the IOS system. After the message received in the text input box is sent out by using the underlying communication module of the IOS system, the message corresponding to the message ID may further be marked as read. When there is only one message currently, after the message received in the text input box is sent out by using the underlying communication module of the IOS system, that is, after a reply to the message is made, the pop-up window may be closed automatically; and a use state of an application paused previously, for example, a game state of an ongoing game or a lock state of a screen, is restored after the pop-up window is closed.

By using the control for marking a message as read as an example, this control is provided so that the user directly marks a message that does not need a timely reply, a message that does not need a reply, or a message that the user does not want to reply to, as read, which avoids interference from the message being in an unread state for a long time. The message content is displayed in the pop-up window; the user views the message content, and taps the control for marking a message as read in the pop-up window when the user thinks that the message does not need a timely reply or does not need a reply or when the user does not want to reply to the message; the pop-up window receives a marking-as-read instruction by using the control for marking a message as read, and the message corresponding to the message ID is marked as read according to the received marking-as-read instruction. After the message corresponding to the message ID is marked as read, the pop-up window can be closed, and a use state of an application paused previously, for example, a game state of an ongoing game or a lock state of a screen, is restored after the pop-up window is closed.

By using the message deletion control as an example, this control is provided so that the user deletes in time a message that the user is not interested in. The message content is displayed in the pop-up window; and after viewing the message content, the user may be not interested in the message, or consider that the message is meaningless, for example, the message is an advertisement message, a traffic reminding message, a call fee reminding message, or the like. The message content is displayed in the pop-up window; after the user views the message content and thinks that the message can be directly deleted right now, the user taps the message deletion control in the pop-up window; the pop-up window receives a deletion instruction by using the message deletion control, and the message corresponding to the message ID is deleted according to the received deletion instruction. After the message corresponding to the message ID is deleted, the pop-up window may be closed, and a use state of an application paused previously, for example, a game state of an ongoing game or a lock state of a screen, is restored after the pop-up window is closed.

The foregoing description is made by using examples in which related processing needs to be performed on a pop-up message in a pop-up window. According to an actual need, the pop-up window may also be directly closed while no processing is performed on the message, and in such case, the user may directly close the pop-up window by tapping a control for closing the pop-up window. A use state of an application paused previously, for example, a game state of an ongoing game or a lock state of a screen, is restored after the pop-up window is closed.

The following describes the foregoing solution of the present disclosure in detail with reference to a specific example.

When receiving a new message, an underlying communication module of an IOS system throws a new message notification in a form of a prompt to a system message program.

In the solution of the present disclosure, a new message notification thrown by an underlying communication module of an IOS system is captured, where the new message notification includes a message identifier (ID), and a message database is queried according to the message ID, to acquire associated information of a message corresponding to the message ID, where the associated information includes, for example, message content, a message type, namely, whether the message is a short messaging service message or an iMessage and/or whether the message is a text message or an image message, a name of the message sender, an image of the message sender, and a number of the message sender.

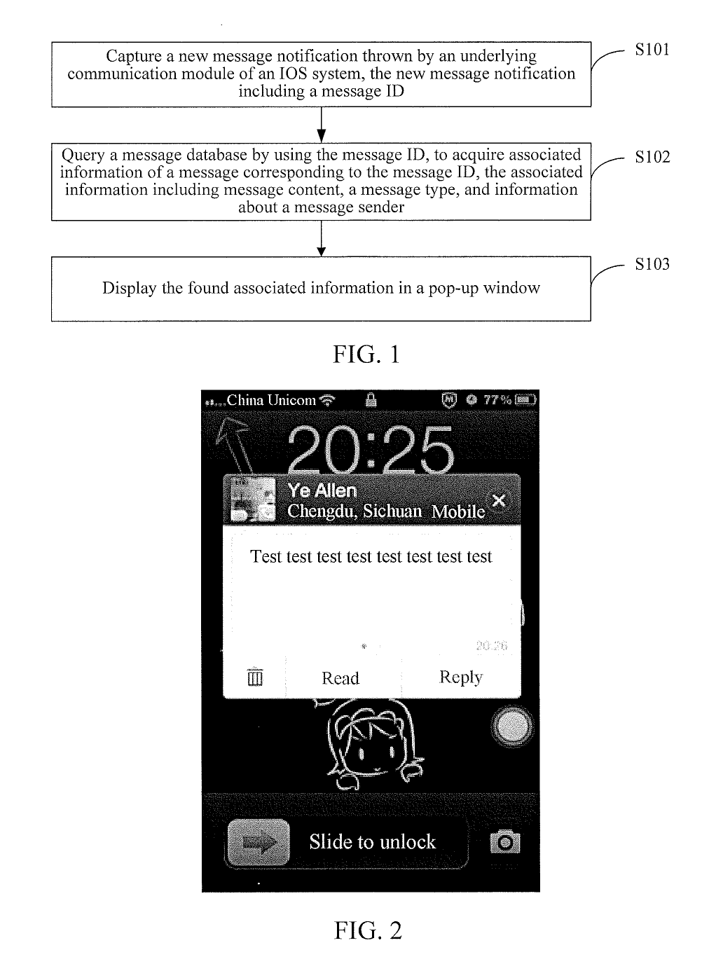

After the associated information of the message is acquired, the associated information is displayed in a pop-up window. When the associated information is displayed, further, a preset alert tone may be played, or a related device may be made to vibrate, so as to inform a user of the new message. By using an example in which the message type is text message, when the pop-up window is displayed, a message deletion control, a message reply control, and a control for marking a message as read may also be displayed in the pop-up window, where the controls may be specifically presented in a form of buttons, as shown in a schematic diagram of message display by using a pop-up window in FIG. 2.

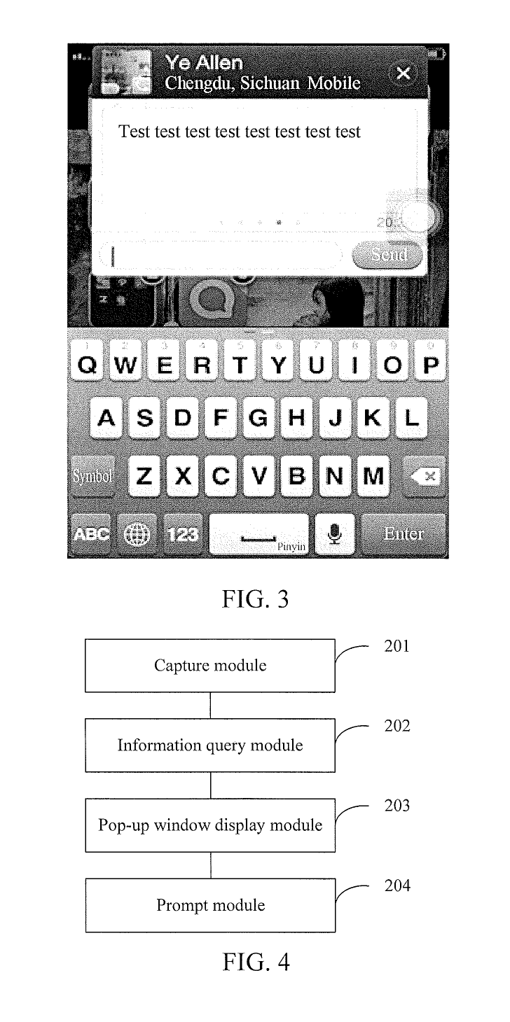

When the new message is displayed in the form of the pop-up window, the user taps the message reply control in the pop-up window when needing to reply to the message, to send a reply instruction; as shown in FIG. 2, the user may press a reply button in the pop-up window. After the reply instruction is received, a text input box is opened in the pop-up window, and a message sending control is provided; as shown in a schematic diagram of message reply in FIG. 3, the user inputs, in the text input box, a reply message that needs to be sent to the other party. After input of the message is completed, the user sends out a message sending instruction by tapping the message sending control, for example, a sending button shown in FIG. 3. After the pop-up window receives the sending instruction, the message received in the text input box is sent out by using the underlying communication module of the IOS system.

After the message received in the text input box is sent out by using the underlying communication module of the IOS system, the message corresponding to the message ID may be marked as read. When there is only one message currently, after the message received in the text input box is sent out by using the underlying communication module of the IOS system, that is, after a reply to the message is made, the pop-up window may be closed automatically; and a use state of an application paused previously, for example, a game state of an ongoing game or a lock state of a screen, is restored after the pop-up window is closed.

According to the foregoing message processing method based on an IOS platform of the present disclosure, the present disclosure further provides a message processing system based on an IOS platform. FIG. 4 is a schematic structural diagram of an embodiment of a message processing system based on an IOS platform according to the present disclosure.

As shown in FIG. 4, the message processing system based on an IOS platform in this embodiment includes one or more processors, memory, and a plurality of program modules stored in the memory and to be executed by the one or more processors, the plurality of program modules further including:

a capture module 201, configured to capture a new message notification thrown by an underlying communication module of an IOS system, where the new message notification includes a message identifier (ID);

an information query module 202, configured to query a message database by using the message ID, to acquire associated information of a message corresponding to the message ID, where the associated information includes, for example, message content, a message type, and information about a message sender, and information about the message sender may be any one or any combination of a name of the message sender, a number of the message sender, an image of the message sender, an address of the message sender, and other information related to the message sender; and

a pop-up window display module 203, configured to display the associated information in a pop-up window found by the information query module 202.

The system of this embodiment captures a notification that is about a new message and is thrown by an underlying communication module of an IOS system; the new message notification includes a unique ID that is in a message database and corresponding to the message, and therefore, the message database may be queried according to the message ID, to acquire all associated information of the message corresponding to the message ID, and after the associated information is acquired, the found associated information is displayed in a pop-up window. In this message processing manner, it is unnecessary to switch to a system message processing program, and a received new message can be displayed in a pop-up window without switching a currently used application; moreover, a related processing operation can be performed on the message when the message is displayed in the form of the pop-up window, thereby implementing quick message processing without switching the application.

As shown in FIG. 4, the message processing system based on an IOS platform in this embodiment may further include:

a prompt module 204, configured to play a preset message alert tone or cause a related device to vibrate when the pop-up window display module 203 displays the found associated information in the form of the pop-up window, so as to inform a user of a new message.

When the pop-up window display module 203 displays the pop-up window, a currently used application may pause, so as to maintain continuity of the currently used program and perform a processing operation on message displayed in the pop-up window. For example, when a game program is executed currently, the game may be set to a pause state, so as to ensure that a procedure of the game is not affected when pop-up window is displayed, and ensure continuity of the game after processing on message content displayed in the pop-up window is completed. If the system is currently in a lock state, the lock state is released temporarily, so that a related processing operation can be performed on the pop-up window; and after message processing is completed, the lock state is automatically restored without the necessity of locking the screen manually. Therefore, it can be known that the pop-up window is displayed on a lock screen, a desktop or an application interface when displaying the found associated information in the pop-up window.

Besides, when the pop-up window display module 203 displays the message content, related optimizing processing may further be performed; when there is excessive message content, the user can view the complete message by sliding the message content up and down, that is, the message content is displayed in a slide manner when a vertical slide instruction is received. On the other hand, multiple messages may be received at the same time, and to make it convenient for the user to view each message, a horizontal slide manner may be employed, so that the user can view each message, that is, the pop-up display window switches to display another message when a horizontal slide instruction is received.

As described above, after the associated information of the message corresponding to the message ID is found in the message database, the pop-up window display module 203 displays the acquired associated information in the pop-up window. In this embodiment, the information displayed in the pop-up window by the pop-up window display module 203 may include, for example, message content, information about a message sender and a message processing control. Besides, the associated information found in the message database may further include a message type, where the message type herein may represent whether the newly received message is a short messaging service message, a multimedia message or an iMessage; moreover, the message type may also represent whether the message is a text message or an image message; further, the pop-up window display module 203 may determine a pop-up window display manner according to the message type when the message content is displayed in the pop-up window.

The message processing control provided in the pop-up window is used to facilitate interaction between the user and these message processing controls, thereby implementing message processing. According to an actual need, other types of message processing controls may further be included; and in this embodiment of the present disclosure, the message reply control, the control for marking a message as read, and the message deletion control are used as examples for description.

The pop-up window display module 203 opens a text input box and provides a message sending control in the foregoing pop-up window when receiving a reply instruction by using the message reply control, and sends out a message received in the text input box by using the underlying communication module of the IOS system when the pop-up window display module 203 receives a message sending instruction by using the message sending control. After the message is sent out, the message corresponding to the message ID may further be marked as read, and the pop-up window may be closed automatically; and a use state of an application paused previously, for example, a game state of an ongoing game or a lock state of a screen, is restored after the pop-up window is closed.

The pop-up window display module 203 marks the message corresponding to the message ID as read when receiving a marking-as-read instruction by using the control for marking a message as read, and closes the pop-up window. After the message corresponding to the message ID is marked as read, the pop-up window may be closed, and a use state of an application paused previously, for example, a game state of an ongoing game or a lock state of a screen, is restored after the pop-up window is closed.

The pop-up window display module 203 deletes the message corresponding to the message ID when receiving a deletion instruction by using the message deletion control, and closes the pop-up window. After the message corresponding to the message ID is deleted, the pop-up window may be closed, and a use state of an application paused previously, for example, a game state of an ongoing game or a lock state of a screen, is restored after the pop-up window is closed.

The foregoing embodiments only describe several implementation manners of the present disclosure, and their description is specific and detailed, but cannot therefore be understood as a limitation to the patent scope of the present disclosure. It should be noted that a person of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. A message processing method based on an IOS platform, comprising:
at a computing device running on the IOS platform, the computing device having one or more processors and memory for storing a plurality of program modules to be executed by the one or more processors:
capturing a new message notification thrown by an underlying communication module of the IOS system, the new message notification including a message identifier ID;
querying a message database by using the message ID, to acquire associated information of a message corresponding to the message ID, the associated information including one or more of message content, a message type, and information about a message sender;
displaying the found associated information in a pop-up window, the pop-up window further including a message processing control, the message processing control including any one or any combination of a message reply control, a control for setting a message as read, and a message deletion control;
in response to a reply command received by the message reply control, opening a text input box in the pop-up window and a message sending control; and
in response to a message sending instruction, sending a message received in the text input box by the underlying communication module of the IOS system.

2. The method according to claim 1, further comprising: when the message content is displayed in the pop-up window, displaying the message content by sliding up and down upon reception of a vertical slide instruction, and switching to display another message upon reception of a horizontal slide instruction.

3. The method according to claim 1, further comprising: marking the message corresponding to the message ID as read after sending out the message received in the text input box by using the underlying communication module of the IOS system.

4. The method according to claim 1, further comprising:
when the control for marking a message as read receives a marking-as-read instruction, setting the message corresponding to the message ID as read and closing the pop-up window; and
when the message deletion control receives a deletion instruction, deleting the message corresponding to the message ID and closing the pop-up window.

5. The method according to claim 1, further comprising: playing a preset message alert tone or causing a device running the IOS system to vibrate when displaying the found associated information in the pop-up window.

6. The method according to claim 1, further comprising:
setting a currently used application to a pause state when displaying the found associated information in the pop-up window, and restoring the application to an active use state when the pop-up window is closed; and/or
displaying the pop-up window on top of a lock screen, a desktop or an application interface when displaying the found associated information in the pop-up window.

7. A computing device running on an IOS platform, comprising:
one or more processors;
memory; and
a plurality of program modules stored in the memory and to be executed by the one or more processors, the plurality of program modules further including:
a capture module, configured to capture a new message notification thrown by an underlying communication module of an IOS system, the new message notification including a message identifier (ID);
an information query module, configured to query a message database by using the message ID, to acquire associated information of a message corresponding to the message ID, the associated information comprising one or more of message content, a message type, and information about a message sender;
a pop-up window display module, configured to display the associated information in a pop-up window, the pop-up window display module being further configured to display a message processing control in the pop-up window, the message processing control including any one or any combination of a message reply control, a control for setting a message as read, and a message deletion control; and
wherein the pop-up window display module is configured to open a text input box in the pop-up window and a message sending control in response to a reply command received by the message reply control, and send a message received in the text input box by the underlying communication module of the IOS system in response to a message sending instruction.

8. The computing device according to claim 7, wherein the pop-up window display module is further configured to: when the message content is displayed in the pop-up window, display the message content by sliding up and down upon reception of a vertical slide instruction and switch to display another message upon reception of a horizontal slide instruction.

9. The computing device according to claim 7, wherein the pop-up window display module is further configured to mark the message corresponding to the message ID as read after sending out the message received in the text input box by using the underlying communication module of the IOS system.

10. The computing device according to claim 7, wherein the pop-up window display module is further configured to set the message corresponding to the message ID as read when the control for marking a message as read receives a marking-as-read instruction, and close the pop-up window; and delete the message corresponding to the message ID and close the pop-up window when the message deletion control receives a deletion instruction.

11. The computing device according to claim 7, wherein the plurality of program modules further include: a prompt module, configured to play a preset message alert tone or cause a device running the IOS system to vibrate when the pop-up window display module displays the associated information in the pop-up window.

12. The computing device according to claim 7, wherein the pop-up window display module is further configured to set a currently used application to a pause state when the associated information is displayed in the form of the pop-up window, and restore a use state of the application when the pop-up window is closed; and/or
the pop-up window display module is further configured to display the pop-up window on a lock screen, a desktop or an application interface when the pop-up window display module displays the found associated information in the form of the pop-up window.

13. A non-transitory computer readable medium storing a plurality of program modules in conjunction with a computing device running on an IOS platform and having one or more processors, wherein the plurality of program modules, when executed by the one or more processors, cause the computing device to perform the following operations:
capturing a new message notification thrown by an underlying communication module of the IOS system, the new message notification including a message identifier ID;
querying a message database by using the message ID, to acquire associated information of a message corresponding to the message ID, the associated information including one or more of message content, a message type, and information about a message sender;
displaying the found associated information in a pop-up window, the pop-up window further including a message processing control, the message processing control including any one or any combination of a message reply control, a control for setting a message as read, and a message deletion control;
in response to a reply command received by the message reply control, opening a text input box in the pop-up window and a message sending control; and
in response to a message sending instruction, sending a message received in the text input box by the underlying communication module of the IOS system.

14. The non-transitory computer readable medium according to claim 13, wherein the operations further include:
when the message content is displayed in the pop-up window, displaying the message content by sliding up and down upon reception of a vertical slide instruction, and switching to display another message upon reception of a horizontal slide instruction.

15. The non-transitory computer readable medium according to claim 13, wherein the operations further include:
marking the message corresponding to the message ID as read after sending out the message received in the text input box by using the underlying communication module of the IOS system.

16. The non-transitory computer readable medium according to claim 13, wherein the operations further include:
when the control for marking a message as read receives a marking-as-read instruction, setting the message corresponding to the message ID as read and closing the pop-up window; and
when the message deletion control receives a deletion instruction, deleting the message corresponding to the message ID and closing the pop-up window.

17. The non-transitory computer readable medium according to claim 13, wherein the operations further include:
playing a preset message alert tone or causing a device running the IOS system to vibrate when displaying the found associated information in the pop-up window.

18. The non-transitory computer readable medium according to claim 13, wherein the operations further include:
setting a currently used application to a pause state when displaying the found associated information in the pop-up window, and restoring the application to an active use state when the pop-up window is closed; and/or
displaying the pop-up window on top of a lock screen, a desktop or an application interface when displaying the found associated information in the pop-up window.
